(19) United States
(12) Patent Application Publication
(10) Pub. No.: US 2021/0396629 A1
(43) Pub. Date: Dec. 23, 2021

(54) DEVICE FOR COLLECTING VOLATILE ORGANIC COMPOUNDS

(71) Applicant: L'ETAT FRANÇAIS REPRÉSENTÉ PAR LE MINISTÈRE DE L'INTÉRIEUR, ISSY-LES-MOULINEAUX (FR)

(72) Inventors: Guillaume COGNON, PONTOISE (FR); Vincent CUZUEL, PONTOISE (FR)

(21) Appl. No.: 17/293,075

(22) PCT Filed: Nov. 13, 2019
(86) PCT No.: PCT/FR2019/000184

§ 371 Date: May 12, 2021

(30) Foreign Application Priority Data
Nov. 13, 2018 (FR) FR1871496

(51) Int. Cl. G01N 1/22; G01N 1/24; G01N 1/40; G01N 30/06

(52) U.S. Cl. CPC G01N 1/2214; G01N 1/24; G01N 2001/022; G01N 1/405; G01N 30/06; G01N 1/2273

(57) ABSTRACT

The present invention relates to a sample collection device for collecting volatile organic compounds from the air, as well as to a method for characterizing the volatile organic compounds and to the use of this device for characterizing the odorant signature of an individual and allowing a dog to identify an individual from his/her odorant signature.

The present invention relates to a sample collection device for collecting volatile organic compounds from the air, as well as to a method for characterizing the volatile organic compounds and to the use of this device for characterizing the odorant signature of an individual and allowing a dog to identify an individual from his/her odorant signature.

The field of the invention relates in particular to the field of collecting volatile organic compounds.

Thus far, there are two types of devices for collecting a sample of volatile organic molecules known in the art: on the one hand, devices for direct collection involving placing an adsorbent phase directly on the object or individual to be studied to collect the compounds, and, on the other hand, devices for indirect collection by air suction.

Among the devices for direct collection, compresses are very often used for collecting samples so as to gather a large number of volatile organic molecules, but unfortunately lead to background noise and to contamination due to the presence of non-volatile compounds that influence the laboratory results.

Devices for indirect collection based on air suction, which are generally coupled to a pump, make it possible to reduce the noise generated by the non-volatile compounds and to dispense with the presence of the person during the collection.

Collection devices are thus found in which a pump is coupled to a solid-phase micro-extraction (SPME) device so as to enrich a fiber contained in said device. The principle is based on solvent-free extraction followed by concentration of compounds that are in the state of traces in a liquid or gas by adsorption on a fiber formed of melted silica (Arthur and Pawliszyn, 1990). The SPME device as described in patent EP1955068 and the publication by Meneses et al., 2013, exhibits excessively imprecise results, due to the excessively low amounts adsorbed and due to the contaminations following the air samples. As a result of the adsorption onto melted silica fiber, it is also impossible to reuse the sample for certain additional analyses.

Scent transfer unit (STU) devices are also indirect collection devices, based on the capture, on an adsorbent support such as compresses, of volatile organic molecules present in suctioned air, followed by conventional chromatography (Eckenrode et al., 2006; Ensminger et al., 2010). These devices, as described in U.S. Pat. No. 7,448,288, use sterile compresses or Hungarian compresses directly at the free air at the end of the device, leading to contaminations that influence the subsequent laboratory analyses, as well as the passage of the airflow directly into the pump. Moreover, even the construction of the Scent Transfer Unit (STU) does not make optimum enrichment of the adsorbent support possible.

Finally, canister devices are devices coupled to pumps in active form, making it possible to collect air samples that can subsequently be used to enrich supports such as SPME fibers. These devices are generally made of polished stainless steel treated with a special silica layer so as to facilitate the release of the air. However, there is a risk of reactions of organic molecules with the metal of the canister. In addition, the canisters do not contain a sorbent support, and are dependent on a subsequent method for enriching a sorbent support.

Thus, there is now a need for devices for removing volatile organic compounds that are present in the air in infinitesimal amounts and analyzing them effectively by way of a sorbent support integrated into the device, which will be enriched effectively so as to obtain relevant results and which will be kept from contaminations linked for example to non-volatile compounds.

The Applicant is now making an innovation in the collection of volatile organic compounds by proposing a novel device to meet these needs.

Specifically, the Applicant has developed a device for collecting volatile organic compounds from the air, comprising a collection chamber, a remote pumping system based on an alternation of airflow suction and ejection cycles, a sorbent support, and a circuit providing a system for recirculating the incoming air. In a preferred embodiment, said device comprises single-use connectors. In addition, the invention further comprises a method for characterizing the volatile organic compounds removed using the device and the use of the sorbent support enriched by way of the device according to the invention for characterizing the odorant signature of an individual and allowing a dog to identify an individual from his/her odorant signature.

Thus, in a first aspect, the invention relates to a device for collecting volatile organic compounds from the air, characterized in that it comprises:
a collection chamber;
a remote pumping system based on an alternation of airflow suction and ejection cycles;
a sorbent support;
a circuit providing a system for recirculating the incoming air.

According to the invention and according to Article 2 of European Council Directive 1999/13/EC of 11 Mar. 1999, volatile organic compounds are understood to be compounds containing at least the element carbon and one or more of the following elements: hydrogen, halogens, oxygen, sulfur, phosphorus, silicon or nitrogen, with the exception of carbon oxides and inorganic carbonates and bicarbonates, and having a vapor pressure of 0.01 kPa or more at a temperature of 293.15 K or having a corresponding volatility in the particular conditions of use. They may thus be found on a site, on a surface, in a volume, etc.

Examples of volatile organic compounds identifiable by the device according to the invention may be, without the device being limited to this list:

(−)-Carvone; (±)-Eldanolide; (+)-N-Allyl-α-methylbenzylamine; (1R)-2,6,6-Trimethylbicyclo[3,1.1]hept-2-ene; (1R,3S,4R,5S)-1-Isopropyl-4-; methylbicyclo[3.1.0]hexan-3-yl acetate-rel-; (2R,5R)-2-Methyl-5-(prop-1-en-2yl)-2-vinyltetrahydrofuran; (2R,5S)-2-Methyl-5-(prop-1-en-2-yl)-2-; vinyltetrahydrofuran; (3E,7E)-4,8,12-Trimethyltrideca-1,3,7,11-tetraene; “(3R,3aS,6S,7R)-3,6,8,8-; Tetramethyloctahydro-1H-3a,7-methanoazulen-6-01”; (7a-Isopropenyl-4,5-dimethyloctahydroinden-4-yl)methanol; (E)-3(10)Caren-4-ol; (E)-3-Methyl-5-((1R,4aR,8aR)-5,5,8a-trimethyl-2methylenedecahydronaphthalen-1-yl)pent-2-en-1-ol; (S)-(+)-6-Methyl-1-octanol; (Z)-5-Decene; α-Isomethyl ionone; α,α′-Dihydroxy-m-diisopropylbenzene; α-Bisabolol; α-Cubebene; α-Ethyl-α-methylbenzyl alcohol; α-Ionone; α-Methylstyrene; α-Pinene; β-Hydroxypyruvic acid, trimethylsilyl ether, trimethylsilyl ester; β-Longipinene; β-Myrcene; β-Ocimene; β-Pinene; β-Pinene, 3-(acetylmethyl)-; γ-Terpinene; 1-(2-Pyrazinyl)-1-ethanol; 1(3H)-Isobenzofuranone; 1-(4-Methoxyphenyl)-2,3-dimethylpent-4-en-2-ol; 1-(4-tert-Butylphenyl)propan-2-one; 1,1,4,7-Tetramethyldecahydro-1H-cyclopropa[e]azulene-4,7-diol; 1,10-Dimethyl-2-methylene-trans-decalin; 1,1′-Bicyclooctyl; 1,1′-Biphenyl, 4-methyl-; 1,2-Benzenedicarboxylic acid, bis(2-methylpropyl) ester; 1,2-Cyclohexanediol, 1-methyl-, trans-; 1,2-Cyclohexanediol, 1-methyl-4-(1-methylethenyl)-; 1,2-Ethanediol; 1,2-Ethanediol, monobenzoate; 1,2-Octanediol; 1,2-Pentanediol; 1,3,5-Cycloheptatriene, 2,4-di-t-butyl-1-7,7-dimethyl-; 1,3,5-Hexatriene, 3-methyl-, (Z)-; 1,3,5-Triazine, 1,2,3,4-tetrahydro-3-tert-butyl-6-butylaminomethylthio-; 1,3-Benzodioxole-5-propanal, α-methyl-; 1,3-Butanediol, (S)-; 1,3-Cyclohexanediol, 2-methyl-2-nitro-, monoacetate (ester), [1s-(1α,2β,3α)]-; 1,3-Dimethylbutyl butyrate; 1,3-Dioxane, 2,4-dimethyl-1,3-Dioxolane-2-methanol; 1,3-Octadiene; 1,3-Pentanediol, 2,2,4-trimethyl-; 1,4-Benzenediol, 2,6-bis(1,1-dimethylethyl)-; 1,5-Heptadiene, 3,6-dimethyl-; 1,5-Hexadiene-3,4-diol, 2,5-dimethyl-; 1,5-Hexadiene-3,4-diol, 3,4-dimethyl-; 1,6-Dioxacyclododecane-7,12-dione; 1,6-Nonadien-3-ol, 3,7-dimethyl-; 1,7,7-Trimethylbicyclo[2.2.1]heptan-6-ol; 1,7-Octanediol, 3,7-dimethyl-; 1,8-Nonadiene, 2,7-dimethyl-5-(1-methylethenyl)-; 1,9-Tetradecadiene; 10-Amino-10,11-dihydro-5-acetyldibenz[b,f]azepine; 10-Chlorotricyclo[4.2.2.0(1,5)]dec-7-ene; 10-Methylnonadecane; 10-Undecenal; 10-Undecenenitrile; 13-Methyltetradecanal; 1-Butanamine, N-butyl-N-nitroso-; 1-Butanol, 2-methyl-; 1-Butanol, 3-methyl-, acetate; 1-Butanol, 3-methyl-, benzoate; 1-Butanol, TMS derivative; 1-Decanol; 1-Decanol, 2,2-dimethyl-; 1-Decanol, 2-ethyl-; 1-Decanol, 2-methyl-; 1-Decene; 1-Decene, 2,4-dimethyl-; 1-Decene, 4-methyl-; 1-Dodecanol; 1-Dodecen-3-ol; 1-Ethyl-2-pyrrolidinone; 1H-3a,7-Methanoazulene, octahydro-3,8,8-trimethyl-6-methylene-, [3R-(3α,3aβ3,7β,8aα)]-; 1-Heptanol; 1-Heptanol, 2-propyl-; 1-Hepten-6-one, 2-methyl-; 1-Heptene, 5-methyl-; 1-Hexadecanol, 2-methyl-; 1-Hexene, 4-methyl-; 1H-Inden-1-one, 2,3-dihydro-; 1H-Inden-1-one, 2,3-dihydro-3,3,5,6-tetramethyl-; 1H-Inden-1-one, 2,3-dihydro-3,3-dimethyl-; 1H-Pyrrole, 3-methyl-; 1H-Pyrrole-2-carboxaldehyde, 1-methyl-; 1H-Pyrrolo[3,4-c]pyridine-1,3,4(2H,5H)-trione, 6-methyl-; 1-Methoxy-2-propyl acetate; 1-Nonanol; 1-Nonanol, 4,8-dimethyl-; 1-Nonene; 1-Octanol; 1-Octanol, 2-butyl-; 1-Octanol, 2-methyl-; 1-Octanol, 3,7-dimethyl-, (S)-; 1-Octen-3-ol; 1-Octene; 1-Oxaspiro[2.5]octane, 5,5-dimethyl-4-(3-methyl-1,3-butadienyl)-; 1-Pentadecene; 1-Pentanol; 1-Pentanol, 2-methyl-; 1-Penten-3-one, 1-(2,6,6-trimethyl-2-cyclohexen-1-yl)-; 1-Phenoxypropan-2-ol; 1-Phenyl-2-octanone; 1-Propanol, 2-(2hydroxypropoxy)-; 1-Propanol, 2,2′-oxybis-; 1-Propanol, 2-methyl-; 1-Propylcyclopentene; 1-Tetradecanol; 1-Tetradecanol, methyl ether; 1-Tetradecene; 1-Tetrazol-2-ylethanone; 1-Tridecene; 1-Undecanol; 1-Undecene; 1-Undecene, 4-methyl-; 1-Undecene, 8-methyl-; 1-Undecene, 9-methyl-; 2(3H)-Furanone, 5-butyldihydro-; 2(3H)-Furanone, 5-ethenyldihydro-5-methyl-; 2(3H)-Furanone, 5-ethyldihydro-; 2(3H)-Furanone, 5-ethyldihydro-5-methyl-; 2(3H)-Furanone, 5-heptyldihydro-; 2(3H)-Furanone, 5-hexyldihydro-; 2(3H)-Furanone, 5-methyl-; 2(3H)-Furanone, dihydro-5-(2-octenyl)-, (Z)-; 2(3H)-Furanone, dihydro-5-methyl-; 2(3H)-Furanone, dihydro-5-methyl-5-(2-methylpropyl)-; 2(3H)-Furanone, dihydro-5-methyl-5-phenyl-; 2(3H)-Furanone, dihydro-5-propyl-; 2(5H)-Furanone; 2(5H)-Furanone, 3-methyl-; 2(5H)-Furanone, 5,5-dimethyl-; 2-(Methylsulfonyl)propane; 2,2,4-Trimethyl-1,3-pentanediol diisobutyrate; 2,2-Dimethyl-1,3-butanediol; 2,3-Dichlorobenzonitrile; 2,3-Dichlorobenzyl alcohol; 2,3-Octanedione; 2,4,6-Cycloheptatriene-1-carbonitrile; 2,4,6-Octatriene, 2,6-dimethyl-, (E,Z)-; 2,4,7,9-Tetramethyl-5-decyn-4,7-diol; 2,4-Decadien-1-ol, (E,Z)-; 2,4-Decadienal; 2,4-Dichlorophenethyl alcohol; 2,4-Dimethyl-1-heptene; 2,4-Di-tert-butylphenol; 2,4-Hexadienal, (E,E)-; 2,5-cyclohexadien-1-one, 2,6-bis(1,1-dimethylethyl)-4-hydroxy-4-methyl-; 2,5-Cyclohexadiene-1,4-dione, 2,6-bis(1,1-dimethylethyl)-; 2,5-Dimethyl-1,5-hexadien-3-ol; 2,5-Dimethylhexane-2,5-dihydroperoxide; 2,5-di-tert-Butyl-1,4-benzoquinone; 2,5-Furandione, 3,4-dimethyl-; 2,5-Furandione, 3-methyl-; 2,5-Furandione, dihydro-3-methyl-; 2,5-Furandione, dihydro-3-methylene-; 2,5-Hexanediol, 2,5-dimethyl-; 2,5-Hexanedione; 2,6,10-Trimethyltridecane; 2,6-Dichloroacetophenone; 2,6-Dichlorostyrene; 2,6-Dimethyl-6-nitro-2-hepten-4-one; 2,6-Octadien-1-ol, 3,7-dimethyl-, (Z)-; 2,6-Octadienal, 3,7-dimethyl-, (E)-; 2,6-Octadienal, 3,7-dimethyl-, (Z)-; 2,6-Octadiene, 4,5-dimethyl-; 2-Butanone, 1-(1,3-benzodioxol-5-yl)-; 2-Butanone, 4-(2,2-dimethyl-6-methylenecyclohexyl)-; 2-Butanone, 4-(4-methoxyphenyl)-; 2-Butanone, 4-(5-methyl-2-furanyl)-; 2-Buten-1-ol, 2-ethyl-4-(2,2,3-trimethyl-3-cyclopenten-1-yl)-; 2-Butenal, 2-ethenyl-; 2-Butenal, 2-ethyl-; 2-Butenal, 2-methyl-, (E)-; 2-Butenal, 3-methyl-; 2-Butene ozonide; 2-Butenoic acid, 2-methyl-, 2-methyl-2-propenyl ester, (E)-; 2-Butenoic acid, 3-methyl-; 2-Cyclohexen-1-one; 2-Cyclohexen-1-one, 4-(1-methylethyl)-; 2-Cyclopenten-1-one, 2-methyl-; 2-Cyclopenten-1-one, 2-pentyl-; 2-Cyclopenten-1-one, 4-hydroxy-3-methyl-2-(2-propenyl)-; 2-Cyclopentene-1-carboxylic acid, 1-methyl-, methyl ester; 2-Decanone; 2-Decenal, (E)-; 2-Dodecanone; 2-Dodecene, (E)-; 2-Dodecene, (Z)-; 2-Ethylacrolein; 2-Ethylbutyric acid, dodecyl ester; 2-Ethylbutyric acid, eicosyl ester; 2-Ethylhexanol; 2-Ethylhexyl salicylate; 2-Ethylhexyl trans-4-methoxycinnamate; 2-Ethyl-trans-2-butenal; 2-Ethynyl pyridine; 2-Furancarboxylic acid methyl ester; 2-Furanmethanol, tetrahydro-5-methyl-; 2-Furanone, 2,5-dihydro-3,5-dimethyl; 2-Heptanol, 5-methyl-; 2-Heptanone; 2-Heptene, 3-methyl-; 2-Hexanone; 2-Hexene, 6,6-dimethoxy-2,5,5-trimethyl-; 2-Hexyl-1-octanol; 2H-Pyran, tetrahydro-2-(2-propynyloxy)-; 2H-Pyran-2-one, 6-ethyltetrahydro-; 2H-Pyran-2-one, tetrahydro-; 2H-Pyran-2-one, tetrahydro-6-methyl-; 2H-Pyran-2-one, tetrahydro-6-pentyl-; 2H-Pyran-2-one, tetrahydro-6-propyl-; 2H-Pyran-2-one, tetrahydro-6-undecyl-; 2-hydroxy-2-methyl-4-heptanone; 2-Hydroxy-3-acetyl-6-methyl-4-pyrone; 2-Hydroxy-isobutyrophenone; 2-Isopropenyl-5-methylhex-4-enal; 2-Isopropyl-5-methyl-1-heptanol; 2-Isopropylidene-5-methylhex-4-enal; 2-Methoxy-3-methyl-butyric acid, methyl ester; 2-n-Butyl furan; 2-n-Butylacrolein; 2-n-Octylfuran; 2-Nonadecanone; 2-Nonanone; 2-Nonenal; 2-Nonenal, (E)-; 2-Nonenal, 8-oxo-; 2-Nonene; 2-Norbornyl acetate; 2-Octanone; 2-Octen-1-ol, (E)-; 2-Octen-1-ol, 3,7-dimethyl-; 2-Octen-1-ol, 3,7-dimethyl-, isobutyrate, (Z)-; 2-Octenal, (E)-; 2-Octene, (E)-; 2-Octene, 2-methyl-6-methylene-; 2-Octyn-1-ol; 2-Oxepanone; 2-Pentadecanone; 2-Pentanol, 2,4-dimethyl-; 2-Pentanol, 3-chloro-2-methyl-; 2-Pentanone, 3,3,4,4-tetramethyl-; 2-Pentenal, (E)-; 2-Phenoxyethyl isobutyrate; 2-Phenylethyl acetate; 2-Propanol, 1-(2-butoxy-1-methylethoxy)-; 2-Propanol, 1-(2-methoxy-1-methylethoxy)-; 2-Propanol, 1,1′-[(1-methyl-1,2-ethanediyl)bis(oxy)]bis-; 2-Propanol, 1,1′oxybis-; 2-Propanol, 1-[2-(2-methoxy-1-methylethoxy)-1-methylethoxy]-; 2-Propanol, 1-butoxy-; 2-Propanone, 1-methoxy-; 2-Propen-1-ol, 3-phenyl-; 2-Propenoic acid, (1-methyl-1,2-ethanediyl)bis[oxy(methyl-2,1-ethanediyl)] ester; 2-Propenoic acid, 2-methyl-, 3,3,5-trimethylcyclohexyl ester; 2-Propenoic acid, 3-(2-hydroxyphenyl)-, (E)-; 2-Propenoic acid, tridecyl ester; 2-Propyl-1-pentanol; 2-Pyrrol[tert-butyl(dimethyl)silyl]oxymorphopropan-1-ol; 2-Pyrrolidinone, 1-methyl-; 2-Tetradecanone; 2-Tridecanone; 2-Undecanone; 2-Undecanone, 6,10-dimethyl-; 2-Undecenal; 2-Undecene, 3-methyl-, (Z)-; 2-Undecene, 6-methyl-, (Z)-; 3-((1S,5S,6R)-2,6-Dimethylbicyclo[3.1.1]hept-2-en-6-yl)propanal; 3-(4-Isopropylphenyl)-2-methylpropionaldehyde; 3,5,9-Undecatrien-2-one, 6,10-dimethyl-, (E,Z)-; 3,5-Heptadien-2-one, 6-methyl-, (E)-; 3,6-Dioxa-2,4,5,7-tetrasilaoctane, 2,2,4,4,5,5,7,7-octamethyl-; 3,7-Nonadien-2-ol, 4,8-dimethyl-; 3-Allyl-6-methoxyphenol; 3-Buten-1-ol, 3-methyl-; 3-Buten-2-one, 4-(2,6,6-trimethyl-1 cyclohexen-1-yl)-; 3-Carene; 3-Cyclohexen-1-ol, 1-methyl-4-(1-methylethyl)-; 3-Cyclohexen-1-ol, 4-methyl-1-(1-methylethyl)-, (R)-; 3-Cyclohexene-1-carboxaldehyde; 3-Cyclohexene-1-carboxaldehyde, 1-methyl-; 3-Cyclohexene-1-carboxaldehyde, 2,4,6-trimethyl-; 3-Decene, 2,2-dimethyl-, (E)-; 3-Decenoic acid; 3-Dodecanol; 3-Dodecene, (E)-; 3-Dodecene, (Z)-; 3-Ethyl-4,4-dimethyl-2-(2-methylpropenyl)cyclohex-2-enone; 3-Furanmethanol; 3-Heptyne; 3-Hexanone, 5-methyl-; 3-Hydroxy-3-phenylbutan-2-one; 3-Isopropyl-4-methyl-1-pentyn-3-ol; 3-Methoxy-4-methylheptane; 3-Methoxyacetophenone; 3-Methyl-2-butenoic acid, undec-2-enyl ester; 3-Methylcyclopentyl acetate; 3-Nonanol; 3-Nonanone; 3-Octanol, 3,6-dimethyl-; 3-Octanol, 3,7-dimethyl-; 3-Octanol, acetate; 3-Octanone; 3-Octene, 2,2-dimethyl-; 3-Pentadecanone; 3-Penten-2-one; 3-Penten-2-one, (E)-; 3-Penten-2-one, 4-(2,6,6-trimethyl-2-cyclohexen-1-yl)-; 3-Pentenoic acid, 4-methyl-; 3-Undecene, 4-methyl-; 4-(t-Butyl)benzaldehyde; 4,14-Dimethyl-11-isopropyltricyclo[7.5.0.0(10,14)]tetradec-4-en-8-one; 4,7-methano-1H-inden-5-ol, 3a,4,5,6,7,7a-hexahydro-, acetate; 4,7-Methano-1H-indenol, hexahydro-; 4,8,12-Tetradecatrienal, 5,9,13-trimethyl-; 4-Butoxy-2-butanone; 4-Cyanocyclohexene; 4-Cyclopentene-1,3-dione; 4-Ethylbenzoic acid, cyclobutyl ester; 4-Ethylbenzoic acid, decyl ester; 4-Hepten-3-ol, 4-methyl-; 4H-Inden-4-one, 1,2,3,5,6,7-hexahydro-1,1,2,3,3-pentamethyl-; 4-Methyl-2,4-bis(p-hydroxyphenyl)pent-1-ene, 2TMS derivative; 4-Octanol; 4-Octanone; 4-Phenylsemicarbazide; 4-Terpinenyl acetate; 4-tert-Butylcyclohexyl acetate; 4-Tridecene, (Z)-; 4-Undecene, 5-methyl-; 4-Undecene, 8-methyl-, (Z)-; 5,9-Undecadien-1-yne, 6,10-dimethyl-; 5,9-Undecadien-2-one, 6,10-dimethyl-, (Z)-; 5-Dodecyne; 5-Formylsalicylaldehyde; 5H-1-Pyrindine; 5-Hepten-2-one, 6-methyl-; 5-Heptenal, 2,6-dimethyl-; 5-Hexen-2-one, 5-methyl-; 5-Hexen-2-one, 5-methyl-3-methylene-; 5-Hexenal, 4-methylene-; 5-Hydroxy-2-pyridinecarbaldehyde; 5-Methyl-1-phenyloctane; 5-Nonanol; 5-Nonanone; 5-Tridecene, (Z)-; 6-(5-Methyl-furan-2-yl)-hexan-2-one; 6,6-Dimethyl-2-(3-oxobutyl)bicyclo[3.1.1]heptan-3-one; 6-Dodecene, (E)-; 6-Dodecene, (Z)-; 6-Methoxy-2-hexanol, TMS derivative; 6-Methyl-3,5-heptadiene-2-one; 6-Nonenal, (E)-; 6-Octen-1-ol, 3,7-dimethyl-, acetate; 6-Tridecanol, 3,9-diethyl-; 7,8-Diazabicyclo[4.2.2]deca-2,4,7,9-tetraen-7-oxide; 7-Acetyl-6-ethyl-1,1,4,4-tetramethyltetralin; 7a-Isopropenyl-4,5-dimethyloctahydroindene-4-carboxylic acid; 7-Methyl-octadecane; 7-Octen-2-ol, 2,6-dimethyl-; 7-Tetradecene; 7-Tetradecene, (Z)-; 8-Quinolinol, 2-methyl-; 9-Decen-2-one, 5-methylene-; 9-Dodecyn-1-ol; 9-methylheptadecane; 9-Oxabicyclo[3.3.1]nonan-2-one, 3-methyl-6-(tetrahydro-2H-2-pyranyloxy)-; Acenaphthene; Acetaldehyde; Acetaldehyde, (3,3-dimethylcyclohexylidene)-, (E)-; Acetamide, N,N-dibutyl-; Acetamide, N,N-diethyl-; Acetic acid; Acetic acid, 2-acetoxymethyl-1,2,3-trimethylbutyl ester; Acetic acid, 2-ethylhexyl ester; Acetic acid, 2-propyltetrahydropyran-3-yl ester; Acetic acid, butyl ester; Acetic acid, phenylmethyl ester; Acetone; Acetophenone; Ambrox; Amylene hydrate; Anethole; Arsenous acid, tris(trimethylsilyl) ester; Azulene, 1,2,3,5,6,7,8,8a-octahydro-1,4-dimethyl-7-(1-methylethenyl)-, [1S-(1α,7α,8aβ)]-; Benzaldehyde; Benzaldehyde, 2,4-dichloro-; Benzaldehyde, 2-hydroxy-; Benzaldehyde, 2-methyl-; Benzaldehyde, 3-hydroxy-4-benzyloxy-; Benzaldehyde, 3-methyl-; Benzaldehyde, 4-methoxy-; Benzaldehyde, 4-methyl-; Benzenamine, 2-(1-methylethenyl)-; Benzenamine, N-ethyl-; Benzene, (1-butylheptyl)-; Benzene, (1-butylhexyl)-; Benzene, (1-ethyldecyl)-; Benzene, (1-ethylnonyl)-; Benzene, (1-ethylundecyl)-; Benzene, (1-methyldecyl)-; Benzene, (1-methylnonyl)-; Benzene, (1-pentylheptyl)-; Benzene, (1-propylheptyl)-; Benzene, (1-propylnonyl)-; Benzene, (1-propyloctyl)-; Benzene, 1-(1,5-dimethyl-4-hexenyl)-4-methyl-; Benzene, 1,2,3,4-tetramethyl-; Benzene, 1,2,4-trimethyl-; Benzene, 1,2-dimethoxy-4-(1-propenyl)-; Benzene, 1,3-bis(1-methylethenyl)-; Benzene, 1,3-bis(1-methylethyl)-; Benzene, 1,3-dichloro-; Benzene, 1,3-dichloro-2-methyl-; Benzene, 1,3-dimethyl-; Benzene, 1,4-bis(1-methylethenyl)-; Benzene, 1-ethyl-3-methyl-; Benzene, 1-methoxy-4-pentyl-; Benzene, 1-methyl-4-(1-methylethenyl)-; Benzene, 2-ethyl-1,4-dimethyl-; Benzene, nonyl-; Benzene, propyl-; Benzene, tert-butyl-; Benzeneacetic acid, α-oxo-, methyl ester; Benzenemethanol, α,α,4-trimethyl-; Benzenemethanol, α-ethenyl-α-methyl-; Benzenemethanol, α-methyl-, acetate; Benzenemethanol, 4-(1,1-dimethylethyl)-; Benzenepentanol, γ-methyl-, acetate; Benzenepropanol, α,α-dimethyl-; Benzenesulfonamide, N-ethyl-2-methyl-; Benzoic acid; Benzoic acid, 2,4-dichloro-, ethyl ester; Benzoic acid, 2,6-dichloro-, methyl ester; Benzoic acid, 2-hydroxy-, 2-methylbutyl ester; Benzoic acid, 4-[6-(1,1-dimethylethyl)-2H-1,3-benzoxazin-3(4H)-yl]-; Benzoic acid, undecyl ester; Benzonitrile, 4-(4-propyl-1-cyclohexen-1-yl)-; Benzophenone; Benzothiazole; Benzothiazole, 2-methyl-; Benzyl alcohol; beta-Caryophyllene; Bicyclo[2.2.1]heptan-2-one, 1,3,7,7-tetramethyl-; Bicyclo[2.2.2]octane, 1-methyl-4-(methylsulfonyl)-; Bicyclo[3.1.1]heptan-2-one, 3,6,6-trimethyl-; Bicyclo[3.1.1]heptan-2-one, 6,6-dimethyl-, (1R)-; Bicyclo[3.11]heptan-3-one, 2,6,6-trimethyl-; Bicyclo[3.1.1]heptane, 2,6,6-trimethyl-3-(2-propenyl)-, (1α,2β,3α,5α)-; Biphenyl; Boric acid, 3TMS derivative; Butanal, 2-ethyl-; Butane, 1,1,3-trimethoxy-; Butanedioic acid, hydroxy-, diethyl ester; Butanenitrile, 3-methyl-; Butanoic acid; Butanoic acid, 3-chloro-; Butanoic acid, pentyl ester; Butyl acetate; Butylated Hydroxytoluene; Butyrolactone; Camphene; Camphor; Caprolactam; Carbamic acid, phenyl ester; Carbamodithioic acid, diethyl-, methyl ester; Carbonic acid, eicosyl prop-1-en-2-yl ester; Carbonic acid, nonyl prop-1-en-2-yl ester; Carbonic acid, octadecyl vinyl ester; Carbonic acid, octyl vinyl ester; Carbonic acid, prop-1-en-2-yl undecyl ester; Carbonic acid, tridecyl vinyl ester; Carotol; Cedrol; Cinnamaldehyde, (E)-; Cinnamaldehyde, α-pentyl-; cis-β-Farnesene; cis-3-Hexenyl salicylate; cis-Chrysanthenol; cis-Cyclohexane-1,4-dimethanol, diacetate; cis-Hexahydrophthalide; cis-Thujopsene; Citronellol; Cycloheptane, 4-methylene-1-methyl-2-(2-methyl-1 propen-1-yl)-1-vinyl-; Cycloheptanone; Cycloheptanone, 2-methyl-; Cyclohexane, (2-methylpropyl)-; Cyclohexane, (4-methylpentyl)-; Cyclohexane, 1,1′-(1,2-dimethyl-1,2-ethanediyl)bis-; Cyclohexane, 1,1,2-trimethyl-; Cyclohexane, 1-ethenyl-1-methyl-2,4-bis(1-methylethenyl)-, [1S-(1α,2β,4β)]-; Cyclohexane, 2-ethenyl-1,1-dimethyl-3-methylene-; Cyclohexane, 2-ethyl-1,3-dimethyl-; Cyclohexane, isocyanato-; Cyclohexane, methyl-; Cyclohexane, pentyl-; Cyclohexanemethanol, 4-(1-methylethyl)-, cis-; Cyclohexanemethanol, 4-(1-methylethyl)-, trans-; Cyclohexanol, 1-methyl-4-(1-methylethenyl)-; Cyclohexanol, 2-(1,1-dimethylethyl)-; Cyclohexanol, 4-amino-, trans-; Cyclohexanone; Cyclohexanone, 5-methyl-2-(1-methylethyl)-, cis-; Cyclohexene, 1-methyl-4-(1-methylethyl)-, (R)-; Cyclohexene, 1-methyl-4-(1-methylethylidene)-; Cyclohexene, 4-[(1E)-1,5-dimethyl-1,4-hexadien-1-yl]-1-methyl-; Cyclooctane, methyl-; Cyclooctene, 3-methyl-; Cyclopent-4-ene-1,3-dione; Cyclopenta[g]-2-benzopyran, 1,3,4,6,7,8-hexahydro-4,6,6,7,8,8-hexamethyl-; Cyclopentadecanol; Cyclopentane, 1,2-dibutyl-; Cyclopentane, 1,3-dimethyl-, trans-; Cyclopentane, 1-acetyl-1,2-epoxy-; Cyclopentane, 1-butyl-2-propyl-; Cyclopentane, 1-ethyl-2-methyl-, cis-; Cyclopentane, 1-methyl-1-(2-methyl-2-propenyl)-; Cyclopentane, 1-pentyl-2-propyl-; Cyclopentane, 3-hexyl-1,1-dimethyl-; Cyclopentane, decyl-; Cyclopentane, nonyl-; Cyclopentaneacetic acid, 3-oxo-2-pentyl-, methyl ester; Cyclopentanecarboxylic acid, nonyl ester; Cyclopentanone; Cyclopentanone, 2-(2-octenyl)-; Cyclopentanone, 2-methyl-3-(1-methylethyl)-; Cyclopentene, 1-octyl-; Cyclopropanecarboxaldehyde, 2-methyl-2-(4-methyl-3-pentenyl)-, trans-(±)-; Cyclopropanemethanol, α,2-dimethyl-2-(4-methyl-3-pentenyl)-, [1α(R*),2α]-; Decanal; Decane; Decane, 1,1′-oxybis-; Decane, 2,2-dimethyl-; Decane, 2,6,7-trimethyl-; Decane, 3,6-dimethyl-; Decane, 4-methyl-; Decanenitrile; Decanoic acid; Decanoic acid, methyl ester; Decanoic acid, silver(1+) salt; D-Galactose; D-Glucitol, cyclic 1,3:2,4-bis(phenylboronate) 5,6-diacetate; Dibenzofuran; Dibutyl adipate; Dichloroacetic acid, 4-pentadecyl ester; Di-epi-α-cedrene; Diethyl 2,5-pyridinedicarboxylate; Diethyl Phthalate; Diethylcyanamide; Dimethyl phthalate; Dimethyl sulfone; Dimethylaminomethyl-phosphonic acid diisobutyl ester; Diphenyl ether; D-Limonene; Docosane; Dodecanal; Dodecanamide, N-(2-hydroxyethyl)-; Dodecane; Dodecane, 1-chloro-; Dodecane, 1-methoxy-; Dodecane, 2,6,11-trimethyl-; Dodecane, 4,9-dipropyl-; Dodecanenitrile; Dodecanoic acid; Dodecanoic acid, 1-methylethyl ester; Dodecanoic acid, methyl ester; Dodecyl nonyl ether; Dodecyl octyl ether; E-11(12-Cyclopropyl)dodecen-1-ol; Eicosane; Eicosane, 10-methyl-; Estragole; Estran-3-one, 17-(acetyloxy)-2-methyl-, (2α,5α,17β)-; Ethanedioic acid, diethyl ester; Ethanol; Ethanol, 1-(2-butoxyethoxy)-; Ethanol, 2-(2-butoxyethoxy)-, acetate; Ethanol, 2-(dodecyloxy)-; Ethanol, 2-(hexadecyloxy)-; Ethanol, 2-(hexyloxy)-; Ethanol, 2-(tetradecyloxy)-; Ethanol, 2-butoxy-; Ethanol, 2-nitro-, propionate (ester); Ethanol, 2-phenoxy-; Ethanone, 1-(1-cyclohexen-1-yl)-; Ethanone, 1-(2,3-dihydro-1H-inden-5-yl)-; Ethanone, 1-(2,5-dichlorophenyl)-; Ethanone, 1-(2-methylphenyl)-; Ethanone, 1-(3-methylenecyclopentyl)-; Ethanone, 1-(3-methylphenyl)-; Ethanone, 1,1′-(1,3-phenylene)bis-; Ethanone, 1-(4-(1,1dimethylethyl)phenyl]-; Ethanone, 1-(4-(1-hydroxy-1-methylethyl)phenyl]-; Ethanone, 2,2-dimethoxy-1,2-diphenyl-; ETHYL (S)-(−)-LACTATE; Ethyl 4-acetylbenzoate; Ethyl 7-(2-oxocyclopentyl)heptanoate; Ethyl acetoxycarbamate; Ethyl butyl ketone; Ethyl palmitate; Ethyl Vanillin; Ethylbenzene; Ethylene brassylate; Eucalyptol; Fenchol; Formaldehyde; Formamide, N,N-dibutyl-; Formamide, N,N-diethyl-; Formic acid, butyl ester; Formic acid, ethenyl ester; Formic acid, hexyl ester; Formic acid, tetrahydrofurfuryl ester; Fumaric acid, butyl cis-hex-3-enyl ester; Furan, 2,3-dihydro-; Furan, 2-methyl-; Furan, 2-pentyl-; Furfural; Geraniol; Geranyl acetate; Glycerol 1,2-diacetate; Glycidol; Glycolaldehyde dimethyl acetal; Glycolic acid, 2TMS derivative; Heneicosane; Heptadecane; Heptadecane, 2-methyl-; Heptadecane, 3-methyl-; Heptadecane, 7-methyl-; Heptanal; Heptane; Heptane, 1-chloro-; Heptane, 2,4,6-trimethyl-; Heptane, 4-methyl-; Heptanediamide, N,N′-di-benzoyloxy-; Heptanoic acid; Heptanonitrile; Hexadecanal, 2-methyl-; Hexadecane; Hexadecane, 2,6,10,14-tetramethyl-; Hexadecane, 2-methyl-; Hexadecanoic acid, methyl ester; Hexadecene; Hexanal; Hexanal, 2-ethyl-; Hexane, 2,3-dimethyl-; Hexane, 2-methyl-; Hexane, 3,3,4-trimethyl-; Hexane, 3-methyl-; Hexanoic acid; Hexanoic acid, 2-ethyl-; Hexanoic acid, 3,5,5-trimethyl-, 2-ethylhexyl ester; Hexyl octyl ether; Hexylene glycol; Hydrazinecarbothioamide, N-methyl-; Hydrogen azide; Indane; Indo)-2-one, 3-[2-(4-tert-butylphenyl)-2-oxoethyl]-3-hydroxy-5-methyl-1,3-dihydro-; Indole; Isobornyl acetate; Isobutyl acetate; Isolongifolol; Isoneral; Isophorone; Isopinocarveol; Isopropoxycarbamic acid, ethyl ester; Isopropyl Alcohol; Isopropyl myristate; Isopropyl palmitate; Isopropylcyclobutane; Isopulegol; Isopulegol acetate; L-α-Terpineol; Lactic acid; Lilial; Limonene; Linalool; Linalyl acetate; Lincomycin; Longifolenaldehyde; Longifolene; I-Pantoyl lactone; I-Valine, N-(3-methyl-1-oxobutyl)-, methyl ester; Malonic acid, bis(2-trimethylsilylethyl ester; m-Aminophenylacetylene; m-Chloroaniline; Menthol; Mesitylene; Methacrolein; Methanone, (1-hydroxycyclohexyl)phenyl-; Methoxyacetic acid, 2-ethylhexyl ester; Methyl 5-acetyl-2-methoxybenzoate; Methyl 7,9-tridecadienyl ether; Methyl Alcohol; Methyl anthranilate; Methyl Isobutyl Ketone; Methyl octanoate; Methyl salicylate; Methyl tetradecanoate; Methylamine, N-(1-methylheptylidene)-; Methylparaben; Myroxide; N,N′-Diacetylethylenediamine; N,N-Diethyl-N′-formyl-N′-methoxyurea; Naphthalene; Naphthalene, 1,2,3,5,6,8a-hexahydro-4,7-dimethyl-1-(1-methylethyl)-, (1S-cis)-; Naphthalene, 1,6,7-trimethyl-; Naphthalene, 1,7-dimethyl-; Naphthalene, 1-methyl-; Naphthalene, 2,3-dimethyl-; Naphthalene, 2,7-dichloro-; Naphthalene, 2-methoxy-; Naphthalene, decahydro-, trans-; n-Butyl ether; n-Caproic acid vinyl ester; n-Decanoic acid; Neophytadiene; n-Hexane; n-Hexyl salicylate; Nitric oxide; n-Nonadecanol-1; n-Nonylcyclohexane; Nona-3,5-dien-2-one; Nonanal; Nonane; Nonane, 1-chloro-; Nonane, 2-methyl-5-propyl-; Nonane, 3-methyl-; Nonane, 5-(1-methylpropyl)-; Nonane, 5-(2-methylpropyl)-; Nonanenitrile; Nonanoic acid; n-Pentadecanol; n-Tridecan-1-ol; Oct-3-enoic acid, oct-3-en-2-yl ester; Octadecane; Octadecane, 6-methyl-; Octanal; Octanal, 2-(phenylmethylene)-; Octanal, 7-methoxy-3,7-dimethyl-; Octane; Octane, 1,1′-oxybis-; Octane, 1-chloro-; Octane, 2,7-dimethyl-; Octane, 3,5-dimethyl-; Octane, 4-methyl-; Octanenitrile; Octanoic acid; Octanoic acid, octyl ester; Octyl tetradecyl ether; o-Cymene; o-Hydroxybiphenyl; Oleic acid, 2-hydroxyethyl ester stearate; o-tert-Butyl cyclohexyl acetate 1; Oxacycloheptadec-8-en-2-one, (8Z); Oxacycloheptadecan-2-one; Oxalic acid, 2-ethylhexyl hexyl ester; Oxalic acid, 2-ethylhexyl isohexyl ester; Oxalic acid, 2-ethylhexyl octyl ester; Oxalic acid, 2-ethylhexyl pentadecyl ester; Oxalic acid, 2TMS derivative; Oxepine, 2,7-dimethyl-; Oxime-, methoxy-phenyl-; Oxirane, 3-ethyl-2,2-dimethyl-; Oxirane, decyl-; Oxiranemethanol, 3-methyl-3-(4-methyl-3-pentenyl)-; o-Xylene; p-Cresol; Pentadecanal-; Pentadecane; Pentadecane, 2,6,10,14-tetramethyl-; Pentadecane, 3-methyl-; Pentadecane, 6-methyl-; Pentadecane, 8-hexyl-; Pentadecanoic acid; Pentanal; Pentane, 1-chloro-; Pentane, 2,3,3-trimethyl-; Pentanedioic acid, dimethyl ester; Pentanoic acid; Pentanoic acid, 2,4-dimethyl-3-oxo-, methyl ester; Phenol; Phenol, 2-(1,1-dimethylethyl)-; Phenol, 2-(1,1-dimethylethyl)-6-methyl-; Phenol, 2,4-dichloro-; Phenol, 3-methyl-; Phenol, 4-(1,1,3,3-tetramethylbutyl)-; phenoxyethanol, TMS derivative; Phenylethyl Alcohol; Phthalic anhydride; Piperonal; p-Menth-8-en-1-ol, stereoisomer; p-Mentha-1,5,8-triene; p-Mentha-1,5-dien-8-ol; Propanal, 2-methyl-3-phenyl-; Propanal, 3-methoxy-; Propanamide, N-acetyl-; Propane, 1,1,3,3-tetramethoxy-; Propane, 1,1-dimethoxy-2-methyl-; Propane, 2-ethoxy-2-methyl-; Propane-1,3-diol, 2-methyl-; Propanedioic acid, 2TMS derivative; Propanoic acid; Propanoic acid, 2,2-dimethyl-; Propanoic acid, 2-(4-(1-formylethyl)phenyl]-, methyl ester; Propanoic acid, 2-methyl-, 1-(1,1-dimethylethyl)-2-methyl-1,3-propanediyl ester; Propanoic acid, 2-methyl-, 2-ethyl-3-hydroxyhexyl ester; Propanoic acid, 2-methyl-, octyl ester; Propanoic acid, 3-(2-hydroxycyclobutylidene)-2-methyl-, [R*,R*-(E)]-; Propanol, [(butoxymethylethoxy)methylethoxy]-; Propylene Carbonate; Propylene Glycol; Propylene ozonide; Propylparaben; p-Xylene; Pyrazine, 2,6-dimethyl-; Pyridine; Pyridine, 3-methyl-; Pyrrole; Pyrrolidine, 1,1′-methylenebis-; Quinoline; Quinoline, 1,2-dihydro-2,2,4-trimethyl-; rotundene; Salicylic acid, 1-methylpropyl ether, 1-methylpropyl ester; sec-Butyl acetate; Spiro[2.4]heptane-5-methanol, 5-hydroxy-; Squalene; Stearic acid hydrazide; Styrene; Tetracosane; Tetradecane; Tetradecane, 2-methyl-; Tetradecane, 3-methyl-; Tetradecane, 5-methyl-; Tetradecanoic acid; Tetrahydropyrrolo[1,2-a]azetidin-2-one; Tetramethyl thiourea; tetramethylpyrazine; Thioacetic acid; Thiocyanic acid, ethyl ester; Thiophene, tetrahydro-2-methyl-; Toluene; trans-p-Ionone; trans-2-Dodecen-1-ol; trans-8-Methyl-1β-acetyl-hydrindane; trans-Decalin, 2-methyl-; Tri(1,2-propyleneglycol), monomethyl ether; Triacetin; Tridecanal; Tridecane; Tridecane, 3-methylene-; Tridecane, 6-methyl-; Tridecanenitrile; Tridecanoic acid; Tridecanoic acid, 3-hydroxy-, ethyl ester; Triethyl citrate; Undec-10-ynoic acid, isobutyl ester; Undecanal; Undecanal, 2-methyl-; Undecane; Undecane, 2,5-dimethyl-; Undecane, 2,7-dimethyl-; Undecane, 2-methyl-; Undecane, 3,6-dimethyl-; Undecane, 3-methyl-; Undecane, 3-methylene-; Undecane, 6-ethyl-; Undecane, 6-methyl-; Undecanenitrile; Undecanoic acid; Vanillin; Z-2-Octadecen-1-ol acetate.

A collection chamber is understood to be the “nose” of the device, in other words the place through which the airflow enters the device.

According to the invention, a remote pumping system based on an alternation of airflow suction and ejection cycles is understood to be an air pumping system that makes it possible not to pollute the system, for example with metal particles from the pump, or with any sort of volatile organic compounds from the plastics or any other element of the pump, or even with vapors residual within the pumping mechanisms from a previous collection that are thus polluting the following collection.

Examples of pumping systems of this type may be peristaltic pumps based on alternating compression and decompression of a pipe or tube in which the gas or liquid is kept, the airflow not passing directly into the pump, or a system using two pumps having complementary properties so as to obtain a pulsed effect, or even a device making it possible under the action of a current to deform a material that will subsequently take on the initial form thereof, the alternation of these deformations generating a pulsed flow of air.

Preferably, said pumping system is a peristaltic pump.

According to the invention, a sorbent support is understood to be a support capable of retaining the volatile organic compounds contained in the airflow that passes through it. According to the invention, retaining the volatile organic compounds is understood to mean that they are fixed by a physical and/or chemical process to the surface or interior of said support. This retention is reversible, and the compounds may be released by desorption techniques.

According to the invention, a circuit providing a system for recirculating incoming air is understood to be a system allowing the airflow to be reintroduced into the collection chamber after passing into the sorbent phase and allowing a large part of the air that has already passed through the sorbent support to be repumped by the device to enrich the sorbent support once again.

Preferably, according to the invention, the sorbent support is an absorbent support. An absorbent support is understood to be a support capable of implementing a physical and/or chemical process so as to allow the volatile organic compounds to enter the inside thereof and to retain them. This retention is reversible, and the compounds may be released by desorption techniques.

Preferably, according to the invention, said absorbent support is selected from the cyclodextrins, sodium bisulfite and/or dinitrophenylhydrazine.

Preferably, according to the invention, said sorbent support is an adsorbent support. An adsorbent support is understood to be a support capable of implementing a physical and/or chemical process that brings about retention of the volatile organic compounds on the surface. This retention is reversible, and the compounds may be released by desorption techniques.

Preferably, according to the invention, said adsorbent support is selected from compresses, polydimethylsiloxane patches, graphitized carbon blacks, molecular sieves, alumina, silica, and/or organic polymers, or a combination thereof.

According to the invention, compresses are understood to be pieces of filled gauze conventionally used in the medical field. They include for example sterile hydrophilic compresses and Hungarian compresses.

According to the invention, carbon black or active charcoal, activated charcoal, vegetable coal, furnace black, thermal black, channel black, acetylene black or lamp black is understood to be a form of carbon treated so as to make it highly porous and thus to increase the very high surface area thereof available for the adsorption.

Examples of carbon black as understood according to the invention may be in particular the products known by the names “Carbograph®,” “Carbotrap®” and “Carbopack®.”

According to the invention, molecular sieves are understood to be solid, porous materials having the property of acting as a sieve at the molecular scale. These include in particular crystalline metal aluminosilicates having a three-dimensional interconnecting network of silica and alumina tetrahedra.

Examples of molecular sieves as understood according to the invention may be in particular zeolite or products known by the names “Carbosieves®” and “Carboxen®.”

Examples of organic polymers as understood according to the invention may be in particular the products known by the names “Chromosorb®,” “Porapak®,” “Sorb-Star®,” “Amberlites® XAD” and “Tenax®,” the last of these being formed of Poly(2,6-diphenylphenylene oxide).

Combinations are understood to be multiple supports comprising different types of said supports. These include for example DVB-carboxen-PDMS SPME fibers.

In a particularly preferred manner, according to the invention, said absorbent support is an organic polymer known by the name “Sorb-Star®.”

Preferably, according to the invention, the circuit is closed by sealing the collection chamber during the recirculation of the airflow.

According to the invention, sealing is understood to mean that the collection chamber is closed once the airflow has entered so as to close the circuit.

According to the invention, a closed circuit is understood to mean that the same airflow passes into the sorbent support a plurality of times so as to enrich it.

Preferably, according to the invention, the circuit is formed of single-use connectors.

According to the invention, single-use is understood to mean that said connectors are not intended for reuse and that they may therefore be discarded after use.

These single-use connectors are used so as to limit the risks of contaminating the system.

In a second aspect, the invention relates to a method for characterizing the volatile organic compounds present in the air in a ratio of at least one part per trillion, comprising the steps of:
collecting the volatile organic compounds using the device according to the invention;
withdrawing the sorbent support from said collection device;
desorbing the volatile organic compounds;
gas chromatography;
mass spectrometry.

According to the invention, a “partie par billion (ppb)” is understood to be the French equivalent of English “parts per trillion” (ppt), corresponding to a ratio of 10⁻¹².

According to the invention, collecting volatile organic compounds is understood to mean applying the device according to the invention at the place where the characterization of the volatile organic compounds is required so as to enrich a sorbent support with said volatile organic compounds present at said place.

Preferably according to the invention, this collection of the volatile organic compounds being implemented with the aim of characterizing the odorant signature of an individual.

According to the invention, odorant signature is understood to be an odor that characterizes an individual. The volatile organic compounds are constituent to the human odor, which can be summarized as consisting of 3 types of odor. The primary odor, which is stable over time and characteristic of a person, has a genetic component relating to the major histocompatibility complex, as well as a component linked to the sebaceous and sweat glands and to bacteria. The secondary odor is variable, and formed by endogenous compounds originating, like the primary odor, from the sebaceous and sweat glands and from bacteria, but also from the environment in which the individual has developed, his/her diet, etc. Finally, the tertiary odor is even more variable than the secondary odor, and is formed by exogenous compounds, such as bacteria, and by cosmetics, soaps, perfumes, etc. used by the individual. These components form the odorant signature of an individual.

Preferably according to the invention, said method allows the characterization of the volatile organic compounds present in the air at a ratio of up to one part per thousand.

Preferably according to the invention, this collection is performed at a crime scene.

Preferably according to the invention, said collection is performed in a vehicle.

Preferably according to the invention, said collection is performed close to an industrial production or manufacturing line.

According to the invention, an industrial production or manufacturing line is understood to be a line comprising a sequence of steps, which is implemented for example in a factory and which may be automated or may involve staff and which allows the production or manufacture of a product. This industrial production or manufacturing line may thus discharge volatile organic compounds into the air by virtue of the products, substances or machines that are used.

Preferably according to the invention, said collection is performed close to a patient.

Preferably according to the invention, said collection is performed on a site where a fire has occurred.

Preferably according to the invention, said collection is performed over a period of 1 minute to 24 hours.

In a particularly preferred manner according to the invention, said collection is performed over a period of 5 minutes to 10 hours.

According to the invention, withdrawing the sorbent support means taking said support out of the collection device.

Desorption of the volatile organic compounds is understood to mean the step converse to the sorption, in other words the detachment of the volatile organic compounds from the sorbent support.

Preferably according to the invention, said method is implemented by way of an air sample.

In a particularly preferred manner according to the invention, said air sample comes from a confined space. Non-limiting examples of confined spaces may be a vehicle, a room of a building, or even an elevator.

Preferably, said air sample is of a volume from 1 dm³ to 10 m³ of air.

Preferably according to the invention, said desorption step is a thermodesorption step. According to the invention, a thermodesorption or thermal desorption step means extracting the volatile compounds present on the surface or on the inside of the sorbent support by applying a source of heat.

Preferably according to the invention, the thermodesorption step is implemented by heating to a temperature of between 150° C. and 300° C. for a period of between 1 minute and 60 minutes.

In a particularly preferred manner according to the invention, the thermodesorption step is implemented by heating to a temperature of between 200° C. and 280° C. for a period of between 5 minutes and 20 minutes.

According to the invention, gas chromatography is understood to be a technique for separating the volatile organic compounds as a function of their affinity for a stationary phase.

Preferably according to the invention, the gas chromatography step is a two-dimensional gas chromatography step. This two-dimensional gas chromatography or 2D gas chromatography is characterized in that the compounds are separated using two columns, which are placed in succession and coupled via a modulation system.

According to the invention, a mass spectrometry step is understood to be a technique for detecting and identifying the volatile organic compounds by mass and obtaining structural data.

The chromatography and mass spectrometry steps make it possible to analyze and characterize said volatile organic compounds.

In a third aspect, the invention relates to the use of the device according to the invention to characterize the odorant signature of an individual.

In a fourth aspect, the invention relates to the use of the device according to the invention for enriching a sorbent support and allowing a dog to identify an individual from his/her odorant signature.

According to the invention, a dog is preferably a detection dog trained by police and/or military police services to detect substances or individuals. Non-limiting examples of breeds of detection dog are the Belgian Malinois Shepherd, the German Shepherd, the Tervuren Belgian Shepherd, the Staffordshire Bull Terrier, the Springer Spaniel, the beagle and the bloodhound.

The various aspects of the present invention also suggest various applications thereof, without the invention being limited thereto. Primarily, the invention may be used in forensic science, for example in the search for criminals, the search for hydrocarbons at scenes of fires, or more generally chemical analysis in a broad sense. It may also apply to the field of security, in the search for missing persons, or in the medical field for early diagnosis, for example if molecules indicative of cancers are identified, or even in an industrial sphere such as agro-food, chemistry, pharmaceuticals, etc.

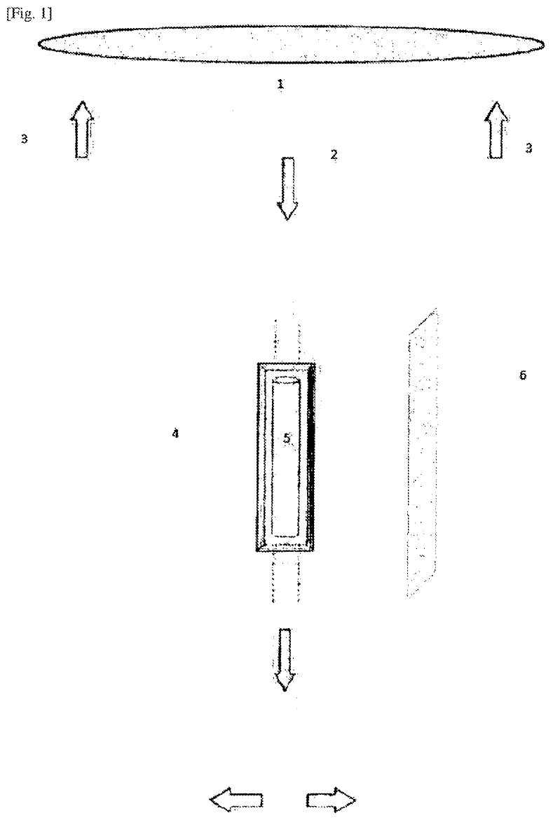

FIG. 1 describes an example of the device according to the invention.

Referring to the drawing, the collection chamber (1) of the device according to the invention makes it possible for air to enter the device. The incoming airflow (2) is carried through the sorbent support (5) by the remote pumping system (4). The recirculating airflow (3) is subsequently redirected to the collection chamber (1) by the connectors (6).

### Example 1: Use of the Device According to the Invention During Search Operations for an Individual

An operator provided with a dry-suit positions the device according to the invention comprising, with reference to the drawings, a collection chamber (1), a remote pumping system (4), a sorbent support (5), and a circuit (6) providing recirculation (3) of the incoming airflow (2) towards the collection chamber, in the passenger compartment of a vehicle in which it is desired to search for the presence of an odorant signature of an individual who may have occupied the vehicle.

The operator starts up the remote pumping system (4) according to the invention so as to enrich the sorbent support (5) according to the invention.

After 30 minutes of use, said pumping system (4) is stopped and the sorbent support (5) is withdrawn from the device according to the invention carefully so as not to contaminate it.

The sorbent support (5) is subsequently sent to a laboratory, and is desorbed by applying a source of heat.

The desorbed elements are subsequently analyzed and identified by bidirectional gas chromatography followed by mass spectrometry, making it possible to characterize the odorant signature present in the vehicle.

This odorant signature may subsequently be compared with that of the individual, characterized in an environment where the person searched for was present, and thus make it possible to reach a conclusion as regards his/her presence in said vehicle.

### Example 2: Use of the Device According to the Invention after a Break-in at a Residence (Break-in, Robbery, Violence Against Individuals, Etc.)

Operators provided with dry-suits arrange a plurality of devices according to the invention in the residence in which the break-in, robbery or violence took place.

The operators start up the pumping systems (4) according to the invention so as to enrich the sorbent supports (5) according to the invention.

After 30 minutes of use, said pumping systems (4) are stopped and the sorbent supports (5) are withdrawn from the devices according to the invention carefully so as not to contaminate them.

The sorbent supports (5) are subsequently sent to a laboratory, and are desorbed by applying a source of heat.

The desorbed elements are subsequently analyzed and identified by bidirectional gas chromatography followed by mass spectrometry, making it possible to characterize the odorant signature present in the residence.

This odorant signature is subsequently used when a suspect is apprehended, once his/her odorant signature has been characterized, so as to compare it and characterize his/her presence at crime scenes.

### Example 3: Use of the Device According to the Invention for Identifying Volatile Organic Compounds that have Entered the Composition of Flammable Products

An operator provided with a dry-suit arranges the device according to the invention in the passenger compartment of a burned-out vehicle in which it is desired to search for the presence of volatile organic compounds capable of entering the composition of flammable products, such as denatured alcohol, fuels, solvents, or even diluents such as white spirit.

The operator starts up the pumping system (4) according to the invention so as to enrich the sorbent support (5) according to the invention.

After 30 minutes of use, said pumping system (4) is stopped and the sorbent support (5) is withdrawn from the device according to the invention carefully so as not to contaminate it.

The sorbent support (5) is subsequently sent to a laboratory, and is desorbed by applying a source of heat.

The desorbed elements are subsequently analyzed and identified by bidirectional gas chromatography followed by mass spectrometry, making it possible to characterize the volatile organic compounds present in the burned-out vehicle.

The identified volatile organic compounds can subsequently be compared with those contained in various flammable products, and the flammable product used to burn the vehicle can thus be identified.

### Example 4: Use of the Device According to the Invention Close to an Industrial Production or Manufacturing Line for Determining the Content of Volatile Organic Compounds Discharged and Exposed to the Staff, and Potentially Identifying a Problem in the Industrial Line

An operator arranges the device according to the invention at the production/manufacturing line for which the emissions of organic compounds are to be determined.

The operator starts up the pumping system (4) according to the invention so as to enrich the sorbent support (5) according to the invention.

After 8 hours of use, said pumping system (4) is stopped and the sorbent support (5) is withdrawn from the device according to the invention carefully so as not to contaminate it.

The sorbent support is subsequently sent to a laboratory, and is desorbed by applying a source of heat.

The desorbed elements are subsequently analyzed and identified by bidirectional gas chromatography followed by mass spectrometry, making it possible to characterize the volatile organic compounds discharged by the production/manufacturing line.

The identified volatile organic compounds can subsequently be compared with those usually discharged by the production line, so as to characterize a manufacturing deviation, linked to a problem on the production line, and the volatile organic compounds to which the staff are being exposed.

### Example 5: Use of the Device According to the Invention in the Medical Sphere in the Context of Non-Invasive Odor Collection for Diagnostic Use (Search for Target Molecules or Markers)

An operator arranges the device according to the invention close to a patient for whom it is desired to determine the presence of volatile organic compounds.

The operator starts up the pumping system (4) according to the invention so as to enrich the sorbent support (5) according to the invention.

After 15 minutes of use, said pumping system (4) is stopped and the sorbent support (5) is withdrawn from the device according to the invention carefully so as not to contaminate it.

The sorbent support (5) is subsequently sent to a laboratory, and is desorbed by applying a source of heat.

The desorbed elements are subsequently analyzed and identified by bidirectional gas chromatography followed by mass spectrometry, making it possible to characterize the volatile organic compounds present in the odor of the patient.

The identified volatile organic compounds can subsequently be compared with those conventionally identified in various pathologies, and the operator can thus decide upon a relevant diagnosis for the patient without invasive collection.

### Example 6: Use of the Device According to the Invention in the Medical Sphere in the Context of a Therapy Follow-Up

An operator arranges the device according to the invention close to a patient for whom it is desired to determine the presence of volatile organic compounds.

The operator starts up the pumping system (4) according to the invention so as to enrich the sorbent support (5) according to the invention.

After 15 minutes of use, said pumping system (4) is stopped and the sorbent support is withdrawn from the device according to the invention carefully so as not to contaminate it.

The sorbent support (5) is subsequently sent to a laboratory, and is desorbed by applying a source of heat.

The desorbed elements are subsequently analyzed and identified by bidirectional gas chromatography followed by mass spectrometry, making it possible to characterize the volatile organic compounds present in the odor of the patient.

The identified volatile organic compounds are subsequently compared with those identified during the previous study implemented for the same patient so as to trace, without invasive collection, the emission of new molecules or markers that could act as an index for the development of a pathology or of the recovery of a patient.

In the context of this example, the use of the device according to the invention is appropriate for obtaining a follow-up on the patient.

1. Device for collecting volatile organic compounds from the air, characterized in that it comprises:
a collection chamber;
a remote pumping system based on an alternation of airflow suction and ejection cycles;
a sorbent support;
a circuit providing a system for recirculating the incoming air.

2. Device according to claim 1, characterized in that said sorbent support is an absorbent support.

3. Device according to claim 1, characterized in that said sorbent support is an adsorbent support.

4. Device according to claim 2, characterized in that said absorbent support is selected from the cyclodextrins, sodium bisulfite and/or dinitrophenylhydrazine.

5. Device according to claim 3, characterized in that said adsorbent support is selected from compresses, polydimethylsiloxane patches, carbon blacks, molecular sieves, and/or organic polymers, or a combination thereof.

6. Device according to claim 1, characterized in that the circuit is closed by sealing the collection chamber during the recirculation of the airflow.

7. Device according to claim 1, characterized in that the circuit is formed of single-use connectors.

8. Method for characterizing the volatile organic compounds present in the air in a ratio of at least one part per trillion, comprising the steps of:
collecting the volatile organic compounds using the device according to the invention;
withdrawing the sorbent support from said collection device;
desorbing the volatile organic compounds;
gas chromatography;
mass spectrometry.

9. Method according to claim 8, characterized in that it is implemented by way of an air sample.

10. Method according to claim 8, characterized in that said desorption step is a thermodesorption step.

11. Method according to claim 8, characterized in that the gas chromatography step is a two-dimensional gas chromatography step.

12. Use of the device according to claim 1 for characterizing the odorant signature of an individual.

13. Use of the device according to claim 1 for enriching a sorbent support and allowing a dog to identify an individual from his/her odorant signature.
